(19) United States
(12) Patent Application Publication
(10) Pub. No.: US 2012/0328294 A1
(43) Pub. Date: Dec. 27, 2012

(54) HIGH SPEED PASSIVE OPTICAL NETWORK ARCHITECTURE

(75) Inventor: David Zhi Chen, Richardson, TX (US)

(73) Assignee: VERIZON PATENT AND LICENSING INC., Basking Ridge (US)

(21) Appl. No.: 13/167,040

(22) Filed: Jun. 23, 2011

(51) Int. Cl. H04J 14/00

(52) U.S. Cl. 398/66

(57) ABSTRACT

A system may include one or more single-mode optical fibers that connect an optical line terminal at a central office to an input cable of an optical splitter in a fiber distribution hub, and one or more dispersion compensating optical fibers that connect an output cable of the optical splitter to an optical network terminal at customer premises. The one or more single-mode optical fibers, the optical splitter, and the one or more dispersion compensating optical fibers may form a communication path, for an optical signal, from the optical line terminal at the central office to the optical network terminal at the customer premises, When the optical signal travels from the optical line terminal at the central office to the optical splitter over the one or more single-mode optical fibers, the optical signal may gain positive dispersion. When the optical signal travels from the optical splitter to the optical network terminal at the customer premises, the optical signal may gain negative dispersion that partially or fully cancels the positive dispersion that the optical signal has gained over the one or more single-mode optical fibers.

### BACKGROUND INFORMATION

Optical signals that travel from a central office to customer premises over optical fibers (beyond 20-50 kilometers) will be attenuated due to fiber loss and distorted due to optical dispersion. At the receiver, at relatively lower baud rates, such as 1 Gigabits per second (Gbps) to 2.5 Gbps, optical dispersion may not be too severe, because the digital bit period is relatively wide with respect to the resulting distortion. Optical dispersion may be significant, however, at higher baud rates that exceed, for example, 10 Gbps, 40 Gbps, and possibly 100 Gbps. In such instances, to restore distorted optical signals to their original form, the optical signals may be sent through dispersion compensators.

### BRIEF DESCRIPTION OF THE DRAWINGS

FIG. 1A illustrates an exemplary optical network in which concepts described herein may be implemented;

FIG. 1B illustrates a portion of the optical network of FIG. 1A;

FIG. 2 is a diagram of a portion of an exemplary multiple dwelling unit of FIG. 1B;

FIG. 3 is a simplified diagram illustrating the optical fibers that run from the exemplary central office of FIG. 1B to an optical network terminal of FIG. 2;

FIG. 4 illustrates an exemplary optical splitter;

FIG. 5 illustrates degradation of an optical signal due to dispersion;

FIG. 6A illustrates an exemplary end-face optical index profile cross-section of a dispersion compensating fiber according to one implementation;

FIG. 6B illustrates an exemplary optical index of refraction profile of the optical fiber of FIG. 6A;

FIG. 7 is a flow diagram of an exemplary process that is associated with laying optical fibers from the central office of FIG. 3 to the optical network terminal of FIG. 3;

FIG. 8A is a flow diagram of an exemplary process that is associated with sending an optical signal from an optical line terminal in the central office of FIG. 3 to the optical network terminal of FIG. 3; and

FIG. 8B is a flow diagram of an exemplary process that is associated with sending an optical signal from the optical network terminal of FIG. 3 to an optical line terminal In the central office of FIG. 3.

### DETAILED DESCRIPTION OF PREFERRED EMBODIMENTS

The following detailed description refers to the accompanying drawings, The same reference numbers in different drawings may identify the same or similar elements.

As described below, a network may provide for communication paths between an optical network terminal in customer premises, an optical splitter, and an optical network terminal in a central office. The network may include a dispersion compensating fiber to connect the optical network terminal in the customer premises to the optical splitter. The network may also include a single-mode fiber to connect the optical splitter to the optical line terminal in the central office. By using the dispersion compensating fiber in place of a bend-insensitive fiber, the network may compensate for positive dispersion related signal degradations/distortions and carry bits at high rates.

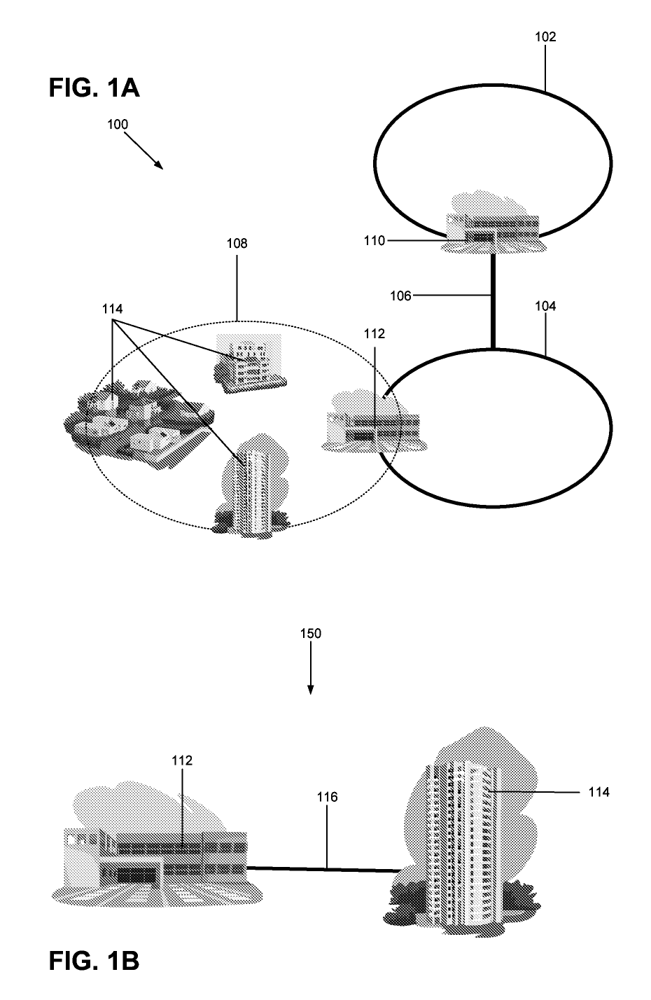

FIG. 1 shows an exemplary optical network 100 in which the concepts described herein may be implemented. As shown, optical network 100 may include metro/regional networks 102 and 104, long haul or ultra-long haul optical lines 106, and edge network 108. Depending on the implementation, optical network 100 may include additional, fewer, or different optical networks and optical lines than those illustrated in FIG. 1. For example, in one implementation, optical network 100 may include additional edge networks and/or metro/regional networks that are interconnected by Synchronous Optical Network (SONET) rings.

Metro/regional network 102 may include optical fibers and central office hubs that are interconnected by the optical fibers. The optical fibers, which may form the backbone of metro/regional network 102, may span approximately 50 to 500 kilometers (km). The central office hubs (also called “central office”), one of which is illustrated as central office hub 110, may include sites that house telecommunication equipment, including switches, optical line terminals, etc. In addition to being connected to other central offices, central office hub 110 may provide telecommunication services to subscribers, such as telephone service, access to the Internet, cable television programs, etc., via optical line terminals.

Metro/regional network 104 may include similar components as metro/regional network 102. Network 104 may operate similarly as network 102. In FIG. 1, metro/regional network 104 is illustrated as including central office hub 112, which may include similar components as central office hub 110. Central office hub 112 may operate similarly as central office hub 110.

Long haul optical lines 106 may include optical fibers that extend from metro/regional optical network 102 to metro/regional network 104. In some implementations, long haul optical lines 106 may span approximately 500 km or more, with proper in-line optical amplifiers and wavelength division multiplexed (WDM) transponders.

Edge network 108 may include optical networks that provide user access to metro/regional network 104. As shown in FIG. 1, edge network 108 may include access points 114 (e.g., office buildings, residential area, etc.) via which end customers may obtain communication services from central office hub 112.

In network 100, each of networks 102, 104, and 108 is exemplary. Accordingly, depending on the implementation, each of networks 102, 104, and 108 may include additional, fewer, or different networks, hubs, and/or access points than those illustrated in FIG. 1A. For example, edge network 108 may include additional access points, central office hubs, etc,

FIG. 1B shows a portion 150 of optical network 100. As shown in FIG. 1B and 1A, portion 150 may be part of edge network 108, and may include central office hub 112, access point 114, and feeder optical fiber cable 116. Depending on the implementation, portion 150 may include additional, fewer, or different components than those illustrated in FIG. 1B, such as, for example, facilities for housing amplifiers.

Access point 114 may include a multiple dwelling unit or single dwelling unit. A multiple dwelling unit may include, for example, apartments, offices, condominiums, and/or other types of occupancy units that are aggregated in a high-rise or another type of building. A single dwelling unit may include attached town houses, single detached houses, condominiums, and/or other types of horizontally aggregated occupancy units, In the following description, for simplicity, access point 114 is described in terms of a multiple dwelling unit 114.

Feeder optical fiber cable 116 may include optical fiber cable bundles that interconnect a multiple dwelling unit complex and/or a single dwelling unit complex to optical line terminals (OLTs) in central office 112.

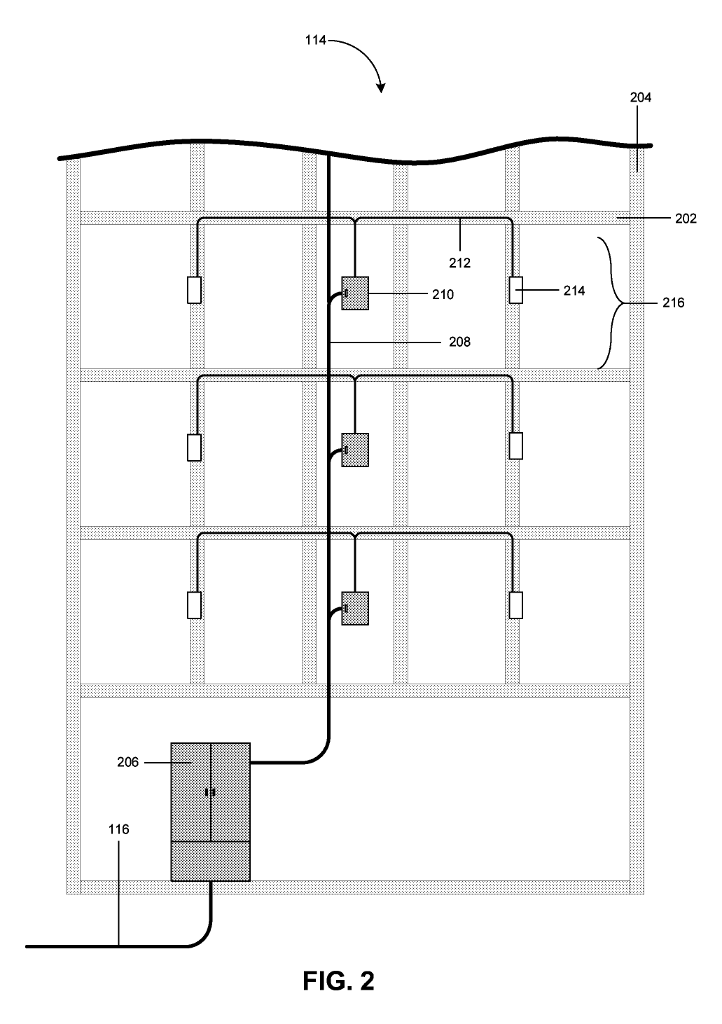

FIG. 2 is a diagram of a portion of multiple dwelling unit 114 (access point 114). As shown,, multiple dwelling unit 114 may include a floor/ceiling 202, a wall 204, a fiber distribution hub 206, a distribution cable bundle 208, a fiber distribution terminal 210, a drop cable 212, a optical network terminal (or optical network unit) 214, and a occupancy unit 216. In FIG. 2, some components of the multiple dwelling unit 114 are omitted for the sake of simplicity (e.g., stairs, doors, elevators, etc.). In addition, depending on the implementation, multiple dwelling unit 114 may include additional, fewer, or different components than those illustrated in FIG. 2. For example, in some implementations, fiber distribution terminal 210 may be connected to fiber distribution hub 206 through another component, such as a collector box that receives ribbon cables, and provides the ribbon cables connectivity to fiber distribution terminals.

Ceiling/floor 202 and wall 204 may partition space within multiple dwelling unit 114 into multiple occupancy units. Fiber distribution hub 206 may include an enclosure (e.g., a plastic or metal cabinet) to receive feeder optical fiber cable 116, split an optical signal on an optical fiber within optical fiber cable 116 into multiple optical signals, convey the split optical signals to fiber distribution cables, collect the fiber distribution cables into distribution cable bundle 208, and provide distribution cable bundle 208 to fiber distribution terminals 210 or to optical network terminals 214.

Distribution cable bundle 208 may include riser cables that carry optical fibers from fiber distribution hub 206 to fiber distribution terminal 210. In some implementations, distribution cable bundle 208 may be tapered as it is routed vertically through multiple dwelling unit 114 and as fiber distribution cables are branched from distribution cable bundle 208 to feed into one or more of fiber distribution terminal 210. Fiber distribution terminal 210 may include an enclosure to receive a fiber distribution cable from distribution cable bundle 208.

Drop cable 212 may include an optical fiber that carries an optical signal from a fiber distribution cable in fiber distribution terminal 210 to optical network terminal 214. Typically, drop cable 212 may be installed in a raceway that is placed along the ceiling of a hallway, in a conduit, in a duct, etc.

Optical network terminal 214, which may also be called optical network unit 214, may receive optical signals via drop cable 212 and convert the received optical signals into electrical signals that are further processed or carried over, for example, copper wires to one or more occupancy units. In some implementations, optical network terminal 214 may be placed within an occupancy unit, and devices that use services offered by central office 112 may be directly connected to optical network terminal 214.

Occupancy unit 216 may include a partitioned space that a tenant or an owner of the occupancy unit 216 may occupy. Occupancy unit 216 may house devices that are attached directly or indirectly, via copper wires, to optical network terminal 214 to receive services that central office 112 provides.

In FIG. 2, distribution cable bundle 208 and drop cable 212 may include dispersion compensating/compensation fiber(s). The dispersion compensating fibers may be resistant to signal degradations that are associated with fiber bends. One reason for such bend-insensitivity may be that the dispersion compensating fiber is designed to have an optical index profile that includes one or more trenches, similar to trench(es) in the optical index profiles of certain types of bend insensitive optical fibers (e.g., G.657-B3 fiber).

In contrast to typical bend-insensitive optical fibers, however, the dispersion compensating fibers also provide negative dispersion. The negative dispersion may compensate for optical pulse deformations caused by positive dispersion that the optical signal incurs as the optical signal is carried over a single-mode optical fiber in optical fiber cable 116,

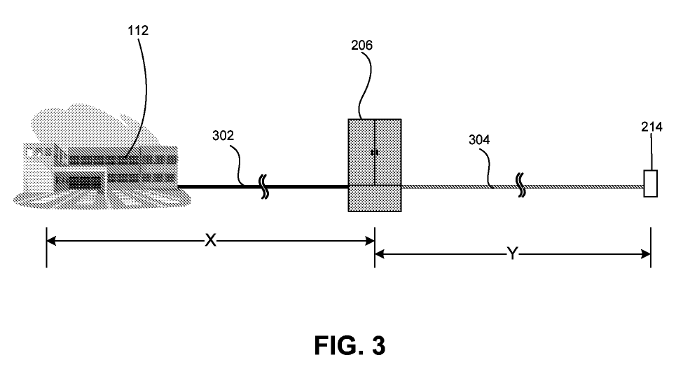

FIG. 3 is a simplified diagram illustrating the optical fibers that run from central office 112 to optical network terminal 214. FIG, 3 shows one or more of single-mode optical fiber 302, which may be bundled within feeder optical fiber cable 116, that run from an optical line terminal (not shown) in central office 112 to fiber distribution hub 206. In addition, FIG. 3 shows dispersion compensating fibers 304 (which may be encased in distribution cable bundle 208 and/or drop cable 212) that run from fiber distribution hub 206 to optical network terminal 214. Dispersion compensating fiber 304 may be selected to have a good bend-insensitive optical properties.

In FIG. 3, for dispersion compensating fibers 304 to provide dispersion compensation to offset signal distortions introduced in single-mode optical fiber 302, the ratio of the length of single-mode optical fiber 302 to the length of dispersion compensating fibers 304 to the length of may be made close to a target ratio (e.g., a ration of 4:1 or 5:1). The target ratio may be determined based on the positive dispersion injected into the optical signal, by single-mode fiber 302, per unit length (e.g., positive dispersion/unit length) and the negative dispersion injected into the optical signal, by dispersion compensating fibers 304, per unit length (e.g., negative dispersion/unit length).

In FIG. 3, the ratio of the length of single-mode fiber 302 to the length of dispersion compensating fibers 304 may be set close to a target ratio. For example, assume that the target ratio is M, and the lengths of single-mode fiber 302 and dispersion compensating fibers 304 are X and Y, respectively. Accordingly, the ratio X/Y may be set close to M by varying either length X or Y. In some implementations, by shortening either single-mode fiber 302 slack or dispersion compensating fibers 304 slack in fiber distribution hub 206, the lengths of single-mode fiber 302 or dispersion compensating fibers 304 may be reduced. The target ratio may be set, for example, such that dispersion compensating fiber 304 provides for sufficient dispersion compensation for the optical signal at a given baud rate (e.g., sufficient compensation to achieve a desired bit error rate at the baud rate). How close the ratio should be set to the target ratio may depend on the dispersion tolerance level at a receiver (e.g., optical network terminal 214) and/or bit error rate (BER) requirements at the receiver. Therefore, in some implementation, even if the length of dispersion compensating fiber 304 is not chosen to provide for elimination of the positive dispersion by 100%, dispersion compensating fiber 304 may still provide for sufficient dispersion compensation and bending insensitivity. The bending insensitivity/tolerance may allow dispersion compensating fiber 304 to be routed through various bends, without following conduits. This allows for cost savings that are associated with fiber deployment in, for example, multiple dwelling units.

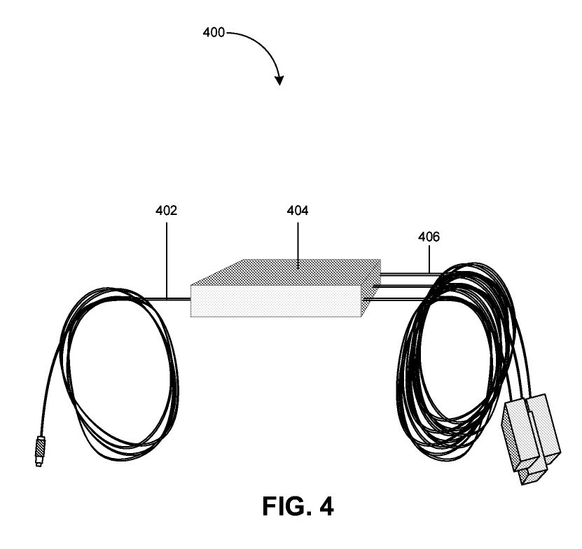

In fiber distribution hub 206, single-mode fiber 302 is attached to dispersion compensating fibers 304 via an optical splitter. FIG. 4 shows an exemplary optical splitter 400. As shown, optical splitter 400 may include an input cable 402, housing 404, and output cables 406. Depending on the implementation, optical splitter 400 may include additional, fewer, different, or different arrangement of components than those illustrated in FIG. 4 (e.g., additional output cables, different geometry of components, different types of housing, etc.).

Input cable 402 may connect to feeder optical cable 116 and carry optical signal to/from feeder optical cable 116 from/to an optical splitter module within housing 404, Housing 404 may encase the optical splitter module. The optical splitter module may receive input optical signal from input cable 402, split the signal into a number of optical signals, and provide the split signals to output cables 406. Output cables 406 may convey the split signals from the optical splitter module within housing 404 to dispersion compensating fibers 304 in, for example, distribution cable bundle 208 or drop cable 212.

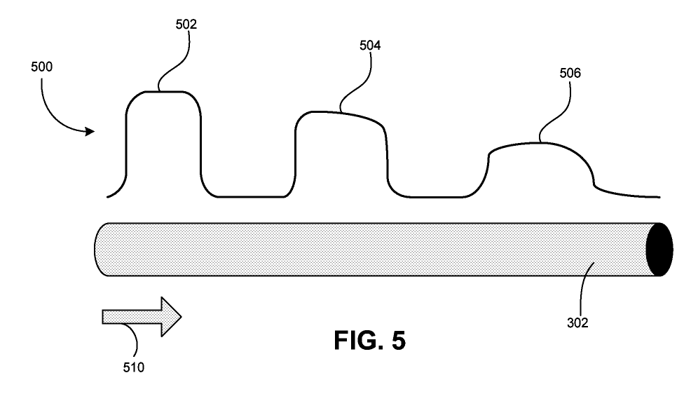

FIG. 5 illustrates degradation of an optical signal 500 due to dispersion, In FIG. 5, as optical signal 500 travels on single-mode fiber 304 in the direction of arrow 510, a pulse 502 suffers from degradations, as illustrated by snap shots 504 and 506 of pulse 502 at different points on single-mode fiber 302. In FIG. 5, pulse 502 tends to flatten, widen, and become misshapen, as shown by snapshots 504 and 506. Although not shown, as pulse 502 continues to travel through dispersion compensating fibers 304, pulse 502 may regain some of its original shape due to negative dispersion imparted by dispersion compensating fibers 304.

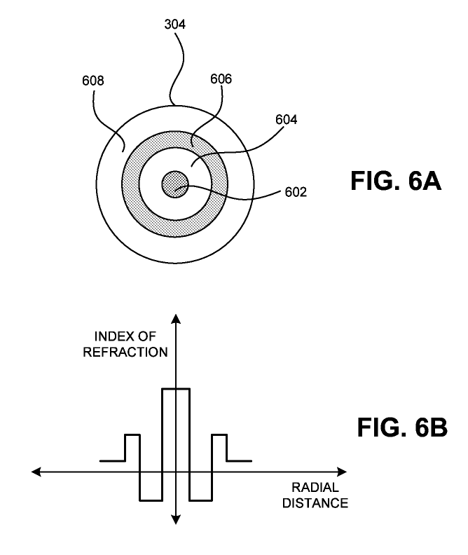

Dispersion compensating fibers 304 may be designed in many ways to provide for negative dispersion to optical signals traveling within. For example, in one design, a dispersion compensating fibers 304 may include one or more trenches. FIG. 6A illustrates an exemplary end-face optical index profile cross section of dispersion compensating fiber 304 according to one implementation. In this implementation, dispersion compensating fiber 304 includes a trench (“trench-assisted” optical fiber). As shown, dispersion compensating fiber 304 may include a core region 602, trench region 604, barrier region 606, and cladding 608, Depending on the implementation, dispersion compensating fiber 304 may include different and/or different arrangement of components than those illustrated in FIG. 6A, For example, in one implementation, dispersion compensating fiber 304 may include a second trench that surrounds barrier layer 606, The design provides for both dispersion compensation and reduction In bending loss.

Core region 602 may include material (e.g., glass, plastic, etc.) that runs along fiber 304's length. Optical signals travel mostly within core 602. Trench region 604 may include material with lower index of refraction than that of core region 602. Optical signals that hit the boundary between core region 602 and trench region 604 are mostly reflected back toward core region 602. Barrier region 606 may have an index of refraction that is greater than that of trench region 606 but lower than that of core region 602, Cladding 608 may include material with an index or refraction lower than that of barrier region 606.

FIG. 6B is the index of retraction profile, of dispersion compensating fiber 304 of FIG. 6A, as a function of radial distance from the axial center of dispersion compensating fiber 304. As shown, the index of refraction at core region 602 is relatively high. In region 604, the index of refraction falls and forms a “trench.” In region 606, the index of refraction appears as a barrier. Although the graph illustrates the index of refraction as changing abruptly at the boundaries between regions 602-606, in an actual implementation, the changes may be gradual. Furthermore, the effective area of trench(es) and fiber mode field diameter of dispersion compensating fiber 304 may be smaller than that those of a bend-insensitive optical fiber,

In some implementations, dispersion compensating fiber 304 may include two or more trenches, In these implementations, the inner trench may provide for negative dispersion. The outer trench may provide for bend-insensitivity. In contrast

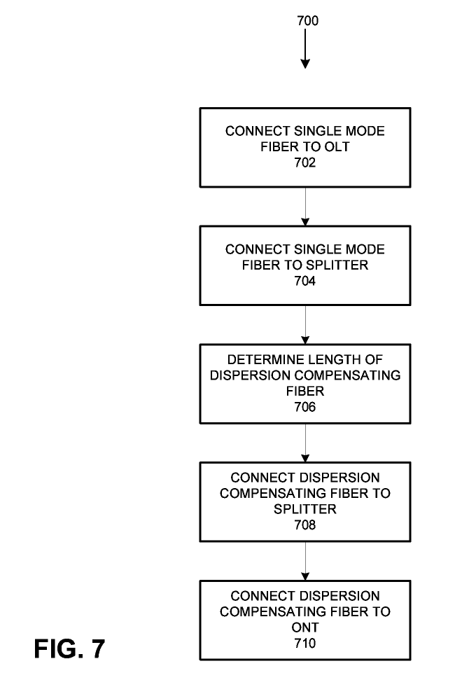

FIG. 7 is a How diagram of an exemplary process 700 that is associated with laying optical fibers from central office 112 to optical network terminal 214. As shown, process 700 may include connecting single-mode optical fiber 302 in feeder optical cable 116 to an optical line terminal in central office 112, and laying feeder optical cable 116 to fiber distribution hub 206 (block 702).

At fiber distribution hub 206, single-mode optical fiber 302 in feeder optical cable 116 may be connected (e.g., spliced or via a connector) to input cable 402 (e.g., an end of an input optical fiber cable) of optical splitter 400 in fiber distribution hub 206 (block 704).

At block 706, the length of dispersion compensating fiber 304 for removing the positive dispersion incurred by an optical signal travelling on single mode optical fiber 302 in feeder optical cable 116 may be determined (block 706). For example, assume that rates at which optical signals on single-mode fiber 302 and dispersion compensating fiber 304 are accrue positive dispersion and negative dispersion are A and B, respectively. Also assume that the length of single-mode fiber 302 is X, respectively. Accordingly, the desired length Y of the dispersion compensating fiber 304 may be approximated by:

Y≈A·X/B (1).

If the distance from fiber distribution hub 206 to optical network terminal is D, and assuming that D is less than or equal to Y, the desired amount of slack S for dispersion compensating fiber 304 in given by:

S=Y−D. (2)

If D is greater than Y, then the length of single-mode fiber 302 can be increased, such that the negative dispersion from dispersion compensating fibers 304 approximately cancels out the positive dispersion from single-mode optical fiber 302. Assuming that E denotes the amount by which the length of single-mode fiber 302 is to be increased (e.g., by splicing in extra optical fiber) to have the overall dispersion of fibers 302 and 304 near zero,

E≈D·B/A−X. (3)

In expression (3), D, B, A, and X are as described above.

Assuming still that D>Y, in some implementations, rather than lengthening single-mode fiber 302, a segment of single-mode optical fiber may be attached to dispersion compensating fiber 304 to form a combination optical fiber. The combination optical fiber may be used in place of dispersion compensating fiber 304 to set the overall dispersion of the optical path from central office 112 to optical network terminal 214 close to zero. The length F of the segment of single-mode fiber, to be spliced with the dispersion compensating fiber, to form the combination fiber is:

F=(B·D−A·X)/(A+B). (4)

In expression (4), it is assumed that single-mode fiber 302 and the segment of single-mode fiber spliced with the dispersion compensating fiber impart positive dispersion to optical signals travelling thereon at the same rate (e.g., A).

Once the appropriate length of single-mode fiber 302, dispersion compensating fiber 304, or the combination fiber is determined, the length of fiber 302, 304, or the combination fiber may be set in accordance with the determined length. In some instances, D may be close enough to Y such that there is no need to provide for slack S or to splice optical fibers (e.g., |D−Y|<T, where T is some threshold).

One end of dispersion compensating fiber 304 (e.g., the length determined at block 706) may be connected to output cable 406 of optical splitter 400 to which single-mode fiber 302 provides input (block 708). In some implementations, the combination fiber may be used in place of dispersion compensating fiber 304,

The other end of dispersion compensating fiber 304 may be connected to optical network terminal 214 (block 710). In implementations that use the combination fiber, the other end of the combination fiber may be connected to optical network terminal 214. Any slack in dispersion compensating fiber 304 may be placed in fiber distribution hub 206.

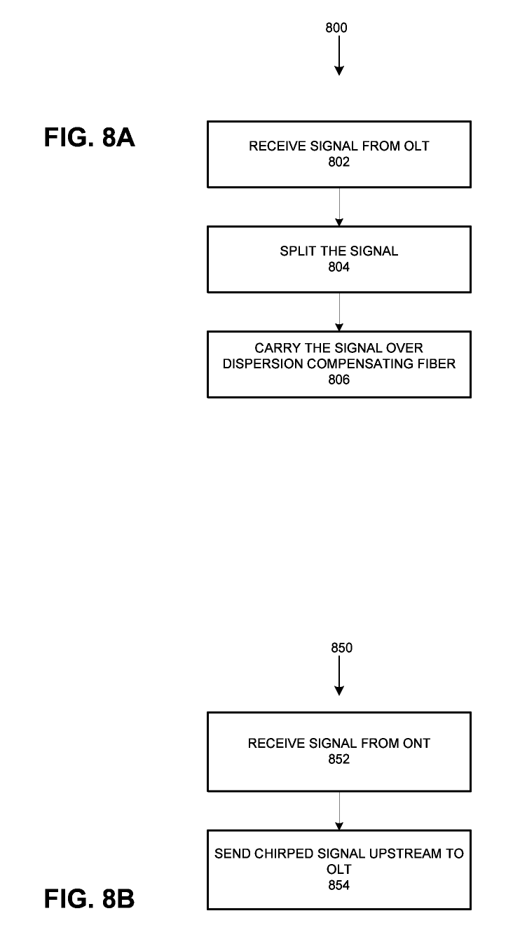

FIG. 8A is a flow diagram of an exemplary process 800 that is associated with transmitting an optical signal from an optical line terminal in central office 112 to optical network terminal 214. Process 800 may include receiving the optical signal from the optical line terminal at one end of single-mode fiber 302 at central office 112 (block 802) and conveying the optical signal over single-mode fiber 302 to optical splitter 400 in fiber distribution hub 206. Conveying the optical signal may add positive dispersion to the signal.

Optical splitter 400 may split the optical signal received via single-mode fiber 302 (block 804). Dispersion compensating fiber 304 may receive the split optical signal from output cable 406 of optical splitter 400 and carry the split signal to optical network terminal 214 (block 806). In conveying the split signal, dispersion compensating fiber 304 may add negative dispersion, to the signal, that may cancel at least some of the positive dispersion in the signal, In addition, because dispersion compensating fiber 304 is bend-insensitive to an extent, the optical signal on dispersion compensating fiber 304 may not incur significant losses around fiber bends,

FIG. 8B is a flow diagram of an exemplary process 850 that is associated with transmitting an optical signal from optical network terminal 214 to the optical line terminal in central office 112. Process 850 may include receiving the optical signal from optical network terminal 214 at one end of dispersion compensating fiber 304 (or a combination fiber) (block 852) and conveying the optical signal over dispersion compensating fiber 304 to optical splitter 400 in fiber distribution hub 206. Conveying the optical signal may add negative dispersion to the signal, producing a chirped optical signal. As indicated above, because dispersion compensating fiber 304 is bend-insensitive, the optical signal on dispersion compensating fiber 304 may not incur significant losses around fiber bends.

Optical splitter 400 may convey the chirped signal received via its output cable 406 from dispersion compensating fiber 302 (block 804) to single-mode optical fiber 302. Single-mode optical fiber 302 may receive the chirped optical signal from input cable 402 of optical splitter 400 and carry the signal to the optical line terminal in central office 112 (block 854). In carrying the signal, single-mode optical fiber 302 may add positive dispersion, to the signal, that cancels out at least some of the negative dispersion in the signal.

In process 850, the chirped optical signal at optical splitter 400 is has higher tolerance to positive dispersion than non-chirped signals. Furthermore, the chirped signal may also be resistant to non-linearity that is associated with high power amplifiers in optical devices and components (e.g., an optical line terminal, optical network terminal, optical amplifier, etc.).

As described above, a network may provide for communication paths between optical network terminal 214 in customer premises, optical splitter 400, and an optical line terminal in central office 112. The network may include, in place of a bend-insensitive fiber, dispersion compensating fiber 304 to connect optical network terminal 214 in the customer premises to optical splitter 400. The network may also include single-mode fiber 302 to connect optical splitter 400 to the optical line terminal in central office 112. By using dispersion compensating fiber 304 in place of a bend-insensitive fiber, the network may compensate for positive dispersion related to signal degradations/distortions and carry bits at high rates.

In this specification, various preferred embodiments have been described with reference to the accompanying drawings. It will, however, be evident that various modifications and changes may be made thereto, and additional embodiments may be implemented, without departing from the broader scope of the Invention as set forth in the claims that follow. The specification and drawings are accordingly to be regarded in an illustrative rather than restrictive sense.

While a series of blocks have been described with regard to the process illustrated in FIGS. 7, 8A, and 8B, the order of the blocks may be modified in other implementations. In addition, non-dependent blocks may represent blocks that can be performed in parallel.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein,

No element, block, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A system comprising:
one or more single-mode optical fibers that connect an optical line terminal at a central office to an input cable of an optical splitter in a fiber distribution hub; and
one or more dispersion compensating optical fibers that connect an output cable of the optical splitter to an optical network terminal at customer premises,
wherein the one or more single-mode optical fibers, the optical splitter, and the one or more dispersion compensating optical fibers form a communication path, for an optical signal, from the optical line terminal at the central office to the optical network terminal at the customer premises,
wherein when the optical signal travels from the optical line terminal at the central office to the optical splitter over the one or more single-mode optical fibers, the optical signal gains positive dispersion, and
wherein when the optical signal, which arrived at the optical splitter from the optical line terminal, travels from the optical splitter to the optical network terminal at the customer premises, the optical signal gains negative dispersion that partially or fully cancels the positive dispersion that the optical signal has gained over the one or more single-mode optical fibers,

2. The system of claim 1, further comprising the optical splitter, configured to split an input optical signal received at the input cable into multiple optical signals, one of which is output at the output cable.

3. The system of claim 1, further comprising a fiber distribution hub, the fiber distribution hub enclosing the optical splitter.

4. The system of claim 3, wherein the fiber distribution hub includes slack in the one or more dispersion compensating optical fibers.

5. The system of claim 3, wherein some portions of the one or more dispersion compensating optical fibers are included in a fiber distribution cable bundle and other portions of the one or more dispersion compensating optical fibers are included in a drop cable, and
wherein the some portions of the one or more dispersion compensating optical fibers and the other portions of the one or more dispersion compensating optical fibers are adjoined via a fiber distribution terminal.

6. The system of claim 1, wherein the customer premises includes a occupancy unit in a multiple dwelling unit or a single dwelling unit.

7. The system of claim 1, wherein a ratio of a length of the one or more single-mode optical fibers to a length of the one or more dispersion compensating optical fibers is one of:
approximately 4 to 1;
approximately 5 to 1: or
approximately equal to a target ratio at which the one or more dispersion compensating optical fibers provide for sufficient dispersion compensation for the optical signal, at a particular baud rate, at the optical network terminal.

8. The system of claim 1, wherein one of the one or more dispersion compensating optical fibers include an optical fiber with one or more trenches.

9. The system of claim 8, wherein the one or more trenches include:
an inner trench configured to provide for the negative dispersion; and
an outer trench configured to provide for bend-insensitivity.

10. The system of claim 1, wherein a length of the one or more dispersion compensating fibers is selected to be approximately equal to a product of:
a first rate, at which the positive dispersion is gained per unit distance travelled by the optical signal over the one or more single mode optical fibers, divided by a second rate, at which the negative dispersion is gained per unit distance travelled by the optical signal over the one or more dispersion compensating optical fibers; and
a length of the one or more single-mode optical fibers.

11. The system of claim 1, wherein when a length of a cabling path from the optical splitter to the optical network terminal is greater than a desired length of the one dispersion compensating optical fiber, a length of the one single-mode optical fiber is decreased.

12. A method comprising:
connecting one end of a single-mode optical fiber to an optical line terminal at a central office;
connecting the other end of the single mode optical fiber to an input of an optical splitter; connecting one end of a dispersion compensating optical fiber to an output of the optical splitter; and
connecting the other end of the dispersion compensating optical fiber to an optical network terminal at customer premises,
wherein the single-mode optical fiber, the optical splitter, and the dispersion compensating optical fiber form a communication path, for an optical signal, from the optical line terminal at the central office to the optical network terminal at the customer premises.

13. The method of claim 12, wherein the dispersion compensating optical fiber is bend insensitive.

14. The method of claim 12, wherein the dispersion compensating optical fiber includes at least one trench.

15. The method of claim 12, wherein when the optical signal travels from the optical line terminal at the central office to the optical splitter over the single-mode optical fiber, the optical signal gains positive dispersion, and
wherein when the optical signal travels from the optical splitter to the optical network terminal at the customer premises over the dispersion compensating optical fiber, the optical signal gains negative dispersion that partially or fully cancels the positive dispersion that the optical signal has gained over the single-mode optical fiber.

16. The method of claim 15, further comprising determining a desired length of the dispersion compensating optical fiber, wherein a magnitude of the negative dispersion is approximately equal to a magnitude of the positive dispersion; and
setting a length of the dispersion compensating optical fiber to the desired length.

17. The method of claim 16, wherein the desired length of the dispersion compensating optical fiber is selected such that a ratio of the length of the dispersion compensating optical fiber to a length of the single-mode optical fiber is approximately equal to a target ratio.

18. The method of claim 16, wherein the desired length of the dispersion compensating fiber is selected to be approximately equal to a product of:
a first rate, at which the positive dispersion is gained per unit distance travelled by the optical signal over the single mode optical fiber, divided by a second rate, at which the negative dispersion is gained per unit distance travelled by the optical signal over the dispersion compensating optical fiber; and
a length of the single-mode optical fiber.

19. The method of claim 16, wherein when a length of a cabling path from the optical splitter to the optical network terminal is greater than the desired length of the dispersion compensating optical fiber, a length of the single-mode optical fiber is decreased.

20. A method comprising:
sending an optical signal from an optical network terminal at customer premises to an optical splitter over a dispersion compensating optical fiber, wherein when the optical signal travels over the dispersion compensating optical fiber, the optical signal gains negative dispersion and becomes a chirped optical signal;
carrying the chirped optical signal from the dispersion compensating optical fiber, via the optical splitter, to a single-mode optical fiber;
carrying the chirped optical signal, from the optical splitter, over the single-mode optical fiber to an optical line terminal at a central office, wherein when the chirped optical signal travels over the single-mode optical fiber, the optical signal gains positive dispersion that reduces or eliminates chirping in the chirped optical signal.
